(19) United States
(12) Patent Application Publication
(10) Pub. No.: US 2014/0129531 A1
(43) Pub. Date: May 8, 2014

(54) Automatic Entity-Grouping for Scalable OLTP

(71) Applicant: NEC Laboratories America, Inc., Princeton, NJ (US)

(72) Inventors: Bin Liu, Santa Clara, CA (US); Junichi Tatemura, Cupertino, CA (US); Vahit Hakan Hacigumus, San Jose, CA (US); Oliver Po, San Jose, CA (US)

(73) Assignee: NEC Laboratories America, Inc., Princeton, NJ (US)

(21) Appl. No.: 14/070,604

(22) Filed: Nov. 4, 2013

Related U.S. Application Data
(60) Provisional application No. 61/723,629, filed on Nov. 7, 2012.

(51) Int. Cl. G06F 9/46; G06F 17/30

(52) U.S. Cl. CPC G06F 9/466; G06F 17/30292
USPC 707/703

(57) ABSTRACT

A method for automatic database design for scalability by receiving a database schema and database workload; applying transaction chopping to split a large transaction into smaller transactions; select one or more transactions using dynamic programming based on transaction weights; deriving a database design that covers the selected transactions; and generating a transaction class design that is scalable.

This application is a utility conversion and claims priority to Provisional Application Ser. 61723629 filed Nov. 7, 2012, the content of which is incorporated by reference.

### BACKGROUND

The present invention relates to Automatic Entity-Grouping for Scalable OLTP.

Internet-scale database applications that run over large clusters often have scalability and availability requirements that demand the relaxation of consistency. In the era of extreme scale, in order for an application to be truly scalable, it must forgo expensive distributed transactions; instead, each transaction of the application must operate on a uniquely identifiable collection of data that lives on a single machine. For example, for an online email service, a collection of data can be defined as a user's personal information (such as name) and all her emails, which can be identified by the user's ID. It is much easier and cheaper to perform atomic operations on a single machine compared to doing the same across multiple machines. For transactions that must access different collections of data that may reside on different machines, consistency is either forgone or achieved at great cost (e.g., distributed transactions); but transactions that access only a single collection are always consistent. In recent literature, the term “entity” is used to refer to tuples in a table, and the term “entity-group” is used to refer to a collection of entities. Hence we refer to systems that uses Helland's initial principles as entity-group systems.

To fully harness the scalability power of entity-group systems, database application developers have yet to define how entity-groups are formed, which is a challenging task. This need can arise especially in the process of migrating applications that were developed for relational database systems (RDBMS) to entity-group systems. Properly forming entity-groups is key to system performance and application consistency. A transaction that accesses only data within an entity-group can be executed with full ACID without resorting to expensive measures such as distributed two-phase commits. On the contrary, a transaction that accesses data from multiple entity-groups either loses consistency (and hence is not a transaction) or has to execute as an expensive distributed transaction. Hence, if entity-groups are too fine-grained, many transactions are forced to access multiple groups. When this happens, some systems use expensive two-phase commits, which cause longer response time; some systems use asynchronous maintenance, which runs at a lower consistency level than serializability. In both cases, either performance or consistency might be excessively compromised. On the other hand, if entity-groups are formed in a too coarsely fashion, the chance that many applications access the same entity-group is increased because it contains more entities (for example, if we partition users by their nationality, it may cause millions of users to be in one entity-group). This means that this large number of requests must be handled by a single machine whose capacity limits the throughput. So there is a delicate balance that needs to be achieved through intelligent design of entity-groups.

This important task of entity-group design has been a manual effort in all the related work. Although some applications have database schemas that naturally form entity-groups (such as the email and blog example applications), many more database applications do not have this luxury, especially when the schema is non-naive (has more than a few relations and complex foreign key relationships). Achieving scalability in large-scale data stores requires careful design of the scope the transactions and how the data objects are grouped together. The design is typically performed by the application developers in a manual and ad-hoc way.

Supporting an online transaction processing (OLTP) workload in a scalable and elastic fashion is a challenging task. Recently, a new breed of scalable systems have shown significant throughput gains by limiting consistency to small units of data called “entity-groups” (e.g., a user's account information together with all her emails in an online email service.) Transactions that access the data from only one entity-group is guaranteed with full ACID, but those that access multiple entity-groups are not. Defining entity-groups has direct impact on workload consistency and performance, and doing so for data with a complex schema is very challenging. It is prone to go to extremes—groups that are too fine-grained cause excessive number of expensive distributed transactions while those that are too coarse lead to excessive serialization and performance degradation. It is also difficult to balance conflicting requirements from different transactions.

Other data stores, such as Google's Megastore, also employees similar concepts, such as entity-group as the building foundation, but they require users to write procedural code to define entity-groups manually. There is no automated mechanism provided. In commercially available entity-group systems (e.g., Google Megastore), creating entity-groups is usually a manual process, which severely limits the usability of those systems.

### SUMMARY

A method for automatic database design for scalability by receiving a database schema and database workload; applying transaction chopping to split a large transaction into smaller transactions; select one or more transactions using dynamic programming based on transaction weights; deriving a database design that covers the selected transactions; and generating a transaction class design that is scalable.

Implementations of the system can include one or more of the following. The system can perform a “transaction chopping” step to split complex transaction into smaller and shorter ones without compromising consistency. Full transaction coverage is supported: a dynamic programming process supports transaction-wise coverage design. This is tailored for the use case where users prefer a 0/1 coverage for their transactions: either a transaction is completely covered by the final design, or it is not. We expect that less experienced users would prefer this type of interaction. The system also provides partial-coverage support: we use collected workload statistics to derive a edge-coverage based method. This method derives designs through a greedy method that always selects the most frequently used joins when there is a conflict. This is to support more fine-grained control over the design, since now users can control whether a particular join in a transaction should be covered in the final design. This is tailored for more experienced users. The system provides a feedback mechanism where users can adjust the weight that is put on individual transactions (in the full-coverage mode) or joins (in the partial-coverage mode). The system takes this input to refine the design to match users' needs. The system can analyze the workload to gather statistics and visualize transactions. We collect the frequency each join appears in the workload. We not only visualize individual queries in the workload, but also stitch them together to form a flow graph so users can better comprehend each transaction.

Advantages of the preferred embodiments may include one or more of the following. The system fully automates the database design process in a structural and repeatable way. For novice users, the system can provide a fully automated mechanism. For expert users who would like more control in the final design, the system can facilitate an assisted design process. The system has reduced complexity: The users do not have to manually derive transaction classes. This greatly reduces the complexity for using elastic relational data stores. The result is faster operation: automated or assisted semi-automated design is much faster than manual operation. The resulting system is also low cost: With greatly reduced effort and labor for designing transaction classes, much labor cost can be saved. The system also automates the entity-group design process. The system provides a user-friendly design tool for automatically creating entity-groups based on a given workload and helps users trade consistency for performance in a principled manner. For advanced users, the system allows them to provide feedback to the entity-group design and iteratively improve the final output.

### BRIEF DESCRIPTION OF THE DRAWINGS

FIG. 1 shows an exemplary process for automatic database design for scalability.

FIG. 2 shows an exemplary process for automatic transaction class (entity-group) design.

FIG. 3 shows an exemplary computer to execute FIGS. 1-2.

### DESCRIPTION

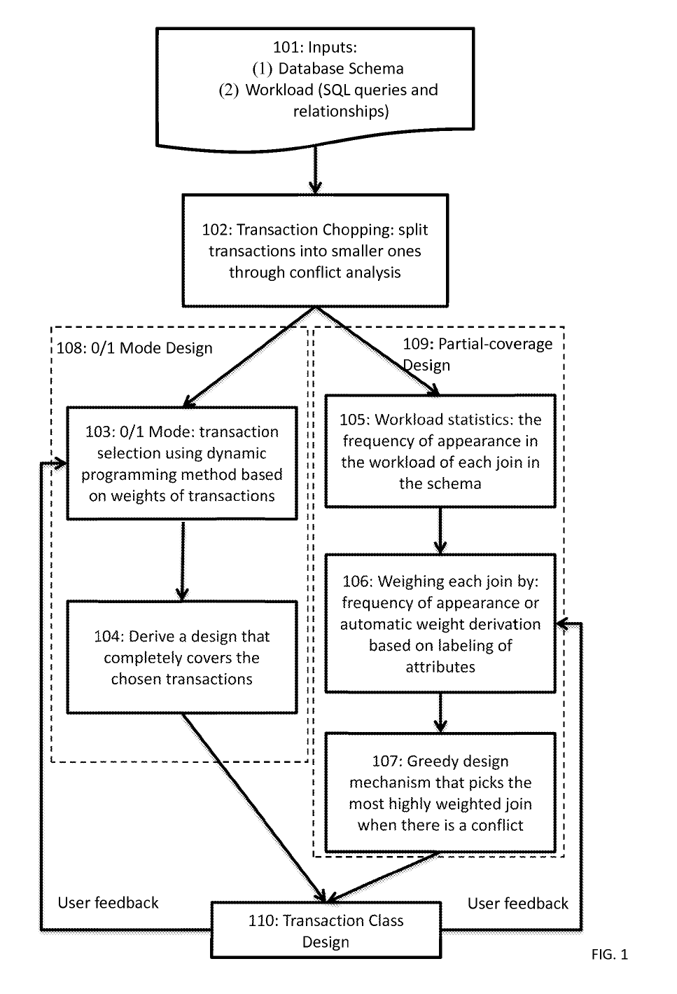

FIG. 1 shows an exemplary process for automatic database design for scalability. In FIG. 1, the process receives a database schema and workload such as SQL queries and relationships. In 102, transaction chopping is done by splitting transactions into smaller ones through conflict analysis. The process then traverses through two options 108 and 109. In path 108 called 0/1 Mode Design, the process performs in 103 a transaction selection process that uses dynamic programming based on weights of transactions. From 103, the process derives a design that completely covers the chosen transactions in 104. Alternatively, in path 109, the process performs partial-coverage design. In 105, workload statistics are captured, and the frequency of appearance in the workload of each join in the schema is determined. Next, in 106, a weighing of each join is done based on the frequency of appearance or automatic weight derivation based on labeling of attributes. A greedy design process is then used to pick the most heighly weighted join when there is a conflict in 107. From 104 or 107, the process performs the transaction class design.

One key step performed by the system of FIG. 1 is the transaction chopping that splits transactions into smaller and shorter ones without compromising consistency for achieving scalable OLTP performance. The system provides a transaction selection that removes conflicts among transactions for supporting full-transaction coverage design. The system also uses weighing schemes (multiplicity and attribute-importance) and the application of a greedy process that supports partial coverage design.

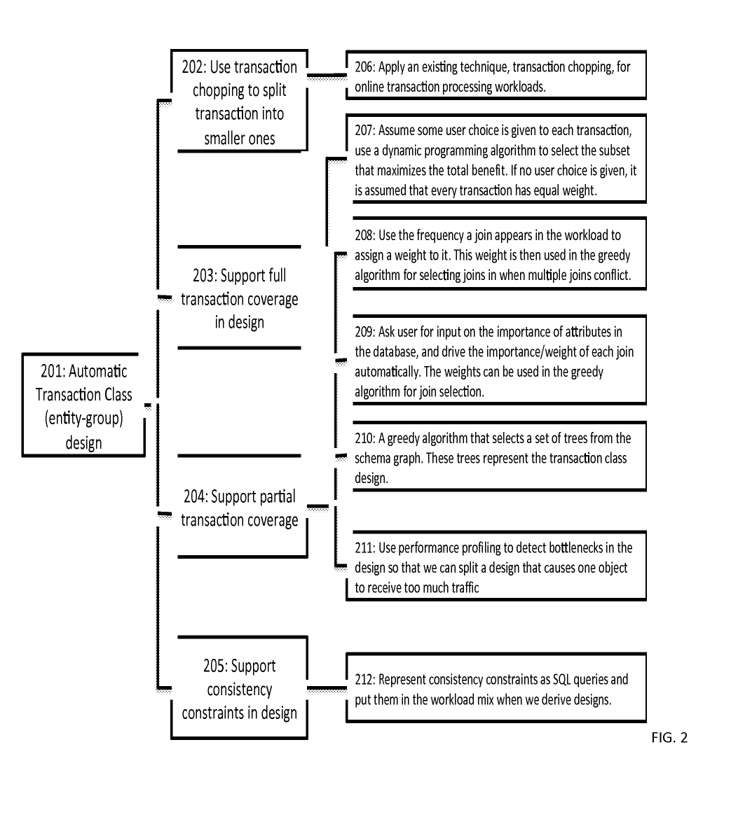

FIG. 2 shows an exemplary process for automatic transaction class (entity-group) design. In 202 and 206, the process uses transaction chopping to split transactions such as online transaction processing workloads into smaller ones. In 203, the process supports full transaction coverage in design. From 203, the process can apply dynamic programming to select a subset of transactions that maximizes total benefit. If no user choice is given, the process assumes that transactions have equal weight. In 204, the process includes supporting partial transaction coverage. In 205, the method includes selecting a set of trees from a schema graph to represent a transaction class design and applying a greedy selection method to select joins.

In 207, the process uses a dynamic programming method that selects the best subset of transactions for transaction class design. In 208, using the frequency that a join appears in a workload to assign a weight to a join and applying the weight in a greedy selection method to select joins in case of conflict. In 209, the process performs assignment of join weights based on the importance of attributes and the position of the join in the data flow that involves the important attributes. This can be done by receiving input from a user on a join's attribute importance and automatically adjusting a weight of the join. In 210, the process includes applying the weight in a greedy selection method to select joins. The greedy method is used for selecting the best join out of multiple joins that conflict with each other, in order to form transaction classes. In 211, the process includes profiling the database's performance and applying the profiling to detect bottlenecks in the design and if needed, splitting the design that causes one object to receive excessive traffic. In 212, the process uses SQL queries to represent consistency for balancing consistency and scalability in the workload. The consistency constraints are represented as SQL queries and the SQL queries can be added in a workload mix when designs are derived.

Next we discuss the details of FIGS. 1-2. We introduce our modeling of a relational database workload for solving the entity-group design problem. We do not attempt to capture the complete semantics of the workload (for example, all different operators in SQL), which is not required for the model. Rather, we model how the workload accesses the database relations (i.e., access patterns). For illustration, we use the schema and transactions based on RUBiS benchmark.

Using the standard technique for schema modeling, we can enrich the graph with edge annotations into a schema graph to serve as the starting point of work (which will become apparent in Sec. 3). We label each edge with the corresponding attributes involved in the relationship. For example, for the edge from relation users to comments, the label id→from_user_id denotes the fact that “from_user_id” in table comments is a foreign key from users (attribute “id”).

We employ a model called transaction graph to represent access patterns of database relations in the workload so that our entity-group design algorithm can take them as input. This model is also used for presenting the workload to the user in our prototype (Sec. 6).

For illustration, we consider three transactions based on RUBiS benchmark:

View Items (T₁): T₁ consists of one query, Q₁, that retrieves all items (“name” and “quantity”) offered by a user given her name. This involves table users and items.

High Bidders (T₂): T₂ contains one query Q₂, which takes input a category id and finds the users (both “id” and “name”) who put the highest bids on each item in this category. This transaction consists of a three-way join between items, bids, and users.

High Bidder Ratings (T₃) Get all ratings and comments for the high bidders retrieved by T₂. Thus T₃ contains two queries: Q₂ (which finds high bidders), and Q₃, which takes as input some users' id (as “to_user_id”), and outputs “ratings”, “id”, and “name” for those users.

A transaction may consist of one or multiple SQL statements, which may be either SELECT, UPDATE, INSERT, or DELETE statements. We refer to each such statement as a query for simplicity. We start with modeling the access pattern of a SQL query (without subqueries), and then adding the interactions among multiple queries.

We represent the access pattern of a query using a query graph, G(V, E), which is a mixed graph (with both directed and undirected edges). We consider query graph examples which represents query Q₁ (T₁) and Q₂ (T₂), respectively.

Each node represents a relation instance that the query accesses (read, write—update, delete, or insert). Each relation instance that appears in a query corresponds to a node in V. If a relation appears in a query multiple times (e.g., self-join), it is represented by multiple nodes with unique IDs.

Each undirected (annotated) edge represents a join between the two relations at the end nodes. Assume a join involves attributes R₁.aᵢ and R₂.aⱼ, we have an edge between node R₁ and R₂, and the edge is annotated with the attributes involved in the join (in this case, R₁.aᵢ and R₂.aⱼ). The edge is undirected because joins can be evaluated from either direction, and for our purpose of designing entity-groups the direction is immaterial.

There is an input node (denoted Input) that represents the source of inputs to the query. There is an edge from Input to each relation that has an input value to some attribute in the where clause of the query. The edge is annotated with the attribute. For example, input to Q₁ is users's “name”.

There is an output node (denoted Output) that represents where data retrieved by the query goes. If query specification requires that certain attributes from a relation instance should be output to the user (in the select clause), we add an edge from the corresponding node to the Output and annotate it with the attributes. For example, output of Q₁ is items “name” and “quantity”.

We now model a transaction as a composition of one or multiple single-block queries. We achieve this by combining the query graphs of all queries in the transaction. In FIG. 4(c), we show the transaction graph of T₃, which is the result of combining the query graphs of Q₂ and Q₃ (not shown explicitly due to simplicity). We merge the query graphs into a transaction graph as follows.

All relation nodes stay intact.

There is one Input node, representing the input to the transaction. Similarly, there is one Output node, for the output of the transaction. Some Input/Output nodes in query graphs may disappear if they are only intermediate. For example, in FIG. 4(c), the Output node has two incoming edges for the three output attributes for the whole transaction.

We capture the access pattern related to multiple queries as follows. If the output of Qᵢ is used in a selection condition in Qⱼ, we connect the relations involved with an undirected edge. An example of such edge is the edge from users to comments.

An entity-group is a collection of tuples that are always allocated on the same machine. Collections are made by grouping tuples by a particular key (e.g. users' ID), which is used to identify each entity group. For example, in the context of an online photo management service that has relations user and photos, a possible way of forming entity-groups is to partition all photos by their owner (user), and identify each entity-group with corresponding user's ID. Entity-group is closely related to the concept of “fragments” in distributed database literature, which refers to part of a relation that is horizontally partitioned (split a relation into collections of rows but preserving all original columns). An entity-group can be considered a group of fragments. Continuing with the photo management example, if we fragment the user table by each user's id, then a fragment of the user relation would be a single user. We can have derived fragments on relations by following foreign keys. Therefore, a derived fragment on photos would be all photos belong to the same user. These two fragments can be considered an entity-group.

An entity-group design captures how to form entity-groups for a database. We illustrate this using an example about relation users and items. We can form entity-groups in the following manner: fragment users by “id”, and follow the foreign-key relationship to fragment items by seller_id. Each entity-group will contain a user, and all the items she sells. Formally, an entity-group design is a forest of rooted trees with directed edges, where each relation in the schema appears as a node in the forest exactly once, and a directed edge represents a foreign-key relationship that is used to define derived fragments. Given this definition of the forest, each tuple in the database is uniquely associated to an entity-group. Edge label indicates how to fragment each relation. In each tree, the attribute used to fragment to the root relation is the group-key, since its value uniquely identifies each entity-group. For visualization, we connect each root relation with a black spade and annotate the edge with the group-key.

In order for a transaction to be ACID with respect to an entity-group design, it must access only one entity-group to get all necessary data. This entity-group should correspond to a design graph that has all the relations the transaction accesses. In addition, the transaction must access the data that is identified by the group-key using only the edges of the corresponding design graph as its access paths. This should become evident after the following example.

Design conflicts ACID for every transaction in the workload may not be achievable for two reasons (which we call design conflicts): i) some transaction has nodes with more than one incoming edge (e.g., two joins involving the same relation on different attributes), ii) multiple transactions need to access the same relation but demand different grouping (e.g., T1 wants users to be grouped by name but T2 needs it to be grouped by category_id). In both cases, we cannot create an entity-group design that is a tree, because we would have multiple incoming edges to a node. So only one transaction's requirement can be met, out of all that conflict on the same relation.

Entity-group design needs to be carefully done to avoid too fine-grained or coarse-grained groups in order to balance consistency and performance. From application developers' point of view, if an access path accesses data from multiple entity-groups, there is potential for loss of consistency or performance. Our system needs to translate this to a numeric metric which we can optimize for, and that is the coverage metric we are going to define next. Another aspect that application developers care about is workload throughput. Although our system does not directly optimize for performance, different design choices do have different performance characteristics, as we will see mostly in the experimental evaluation section (Sec. 5). So throughput is the second objective for design.

Coverage Entity-group systems guarantees ACID only inside each group. If a design does not guarantee ACID for a transaction, application developers typically have to write extra code to incorporate possible inconsistency. One design objective thus is to minimize the need of such compromise. One possible measure towards this objective is coverage: does a design covers transactions in the workload? We can start to define the meaning of coverage in terms of whole transactions. We say that a transaction is fully covered by a design if and only if the design guarantees ACID for the transaction (it is said to be uncovered otherwise). This means that the transaction only accesses data within an entity-group specified by the design. This full coverage metric is easy to understand, but it does not perform well in practice, as we have found through case studies. The reason is, most transactions are quite complex and involve many relations, and it is often impossible to cover them entirely. Thus, we introduce partial coverage: an edge in a transaction graph is covered by a design if data access through the edge is guaranteed to be atomic and isolated. The edge coverage ensures that a subgraph of a transaction graph that is connected only with covered edges can be executed in the ACID manner. For the rest of the paper, when we say “coverage”, we implicitly mean “partial coverage”.

From the viewpoint of the ACID guarantee, we want to achieve a maximal coverage of transactions by a design. To quantify the coverage, we assign a weight to each edge in a transaction graph to mark its relative importance. If an edge weighs more than another, it is more important to cover this edge in the final design. These weights can be provided by a domain expert or automatically derived. In the simplest case, we can assign a weight 1 to each edge, including the ones from Input nodes. Given weighted transaction graphs, we can quantify the coverage of a design as the weighted sum of edges in the transaction graph that are covered by the design graph. Two edges are considered equal if they involve the same pair of relations and attributes. Our objective is then to find the design that achieves the maximum coverage.

The motivation to employ entity-group is to improve the workload performance in terms of throughput. A maximal coverage design would not be useful if it does not yield satisfactory performance gain. Our system provides a design with maximum coverage, from which the user can fine-tune, which may balance consistency and performance. User can employ performance profiling to identify performance issues in a specific design. For example, if a specific entity-group becomes a bottleneck, we should allow users to provide feedback so the system can improve this design and hence throughput.

In this section, we introduce our solution to the automatic design derivation problem. The input to the problem contains: i) a set of transaction graphs T where each edge carries a weight (can be automatically assigned by default or customized by the user), and ii) a schema graph G. The output consists of: i) an entity-group design, and ii) whether each edge in the transaction graphs is covered by the design. Given the output, the developer examines the uncovered part of transaction graphs to consider if the application can compromise for the possible inconsistency. The developer also conducts performance profiling to see if there is any performance bottleneck. Based on the additional ACID requirements and performance bottlenecks identified, the developer can tune the design by designating some edges as necessary to be covered, and our system will refine the design based on this feedback.

Algorithm 1 Compute-Opt Procedure for Computing Non-
conflicting Subset of Transactions with Maximum Total
Utility

Require: T: full set of transaction graphs, cardinality is

| | \|T\| |
|---|---|
| Require: u.: a weight function that assigns a weight value | |
| | to each transaction in T |
| Require: c: for transaction T in T, c(T) is the set of transactions | |
| | that conflict with T |
| Require: M: memoization hash table, M(T′) retrieves the | |
| | optimal utility that can be obtained from the subset T′ |
| Ensure: T_{OPT}: the optimal subset of transactions from T | |
| | with maximum sum of utility |
| 1: | for n=\|T\| to 1 do |
| 2: | T′ ← T′ − Tₙ |
| 3: | if M does not contain key of T′ then |
| 4: | Compute-Opt(T′, M, T_{OPT}) |
| 5: | end if |
| 6: | if M does not contain key of T − c(Tₙ) then |
| 7: | Compute-Opt(T − c(Tₙ), M, T_{OPT}) |
| 8: | end if |
| 9: | if M(T′) >= M(T − c(Tₙ)) + u(Tₙ) then |
| 10: | M ← (T,M(T′)) {store the optimal utility into |
| | hash table with key T} |
| 11: | end if |
| 12: | if M(T′) < M(T − c(Tₙ)) + u(Tₙ) then |
| 13: | M ← (T,M(T − c(Tₙ) + u(Tₙ) |
| 14: | add Tₙ to T_{OPT} |
| 15: | end if |
| 16: | end for |
| 17: | Return T_{OPT} |

Algorithm 2 Greedy Procedure for Edge Coverage Support

| Require: T: set of transaction graphs | |
|---|---|
| Require: Gₛ, database schema graph | |
| Require: w, a weight function that assigns each edge in a | |
| | transaction graph a non-negative weight value |
| Ensure: g_{D}: a set of graphs representing entity-groups | |
| 1: | all edges in Gₛ have an initial weight of 0 |
| 2: | for transaction graph T in T do |
| 3: | for edge e in T do |
| 4: | denote the same edge as e in Gₛ as e′ |
| 5: | w(e′) ← w(e′) + w(e) |
| 6: | end for |
| 7: | end for |
| 8: | for node u in Gₛ do |
| 9: | if in-degree of v > 1 then |
| 10: | for edge e₁ in incoming edges to u do |
| 11: | keep only the edge with largest weight, break ties |
| | randomly |
| 12: | end for |
| 13: | end if |
| 14: | end for |
| 15: | for edge e₁ in Gₛ do |
| 16: | if w(e₁) is 0 then |
| 17: | remove e₁ from Gₛ |
| 18: | end if |
| 19: | end for |
| 20: | g_{D} is the set of connected components in Gₛ |

The edge weight assignment in transaction graphs gives a generic framework to specify the importance of edges (i.e., joins) to be covered as ACID. Nevertheless, requiring a developer to directly assign edge weights is often too tedious. In this section, we provide various weighting schemes integrated into this framework to help developers input their knowledge and preference to the system in an efficient manner.

As a first step, our system employs transaction chopping as a preprocessing step in order to automatically identify edges that can be safely uncovered without compromising consistency. In the original work, transaction chopping can split a set of transactions into smaller and hence shorter-running ones, which leads to improved system concurrency and performance without compromising consistency. In our context, chopping corresponds to removing edges of a transaction graph from coverage consideration. We can safely assign those edges a weight value of zero.

As a baseline, we employ the following scheme, which does not require any additional information from the developer and works as a default weighting scheme.

Multiplicity Weight Scheme Assign a uniform weight to each edge in a transaction graph. After the aggregation step in the algorithm, the weight of an edge in the schema graph is the multiplicity it appears in all the transaction graphs.

On top of the default scheme, there can be various ways to let the developer specify preference in less tedious manner than specifying the weight values for individual edges. In the following, we provide two such examples, namely, predicate annotation and schema annotation.

While a developer may not require full coverage for a transaction, there can be a very important consistency condition the transaction must preserve. We can describe such a condition as a query. Notice that, represented as a query, it can also be converted into a graph just like another transaction. We call it a predicate graph. We let the developer assign the importance of the predicate as a weight value, and overlay this weighted predicate graph onto a transaction graph. As an example, consider the following consistency condition: for RUBiS benchmark, users' bidding transactions must maintain that “item.max_bid” consistently refers to the maximum bid price. This condition can be represented by the following query:
SELECT items.max_bid=max(bids.bid) FROM items, bids WHERE items.id=bids.item_id.

By overlaying this query onto a transaction graph (and Gₛ in Algorithm 4(′)@), the developer can increase the weight of an edge that represents foreign key relationship between items and bids. As evident from this example, a predicate annotation is much more readable for the developers than individual weighting scores on edges in the graph.

We ask the application developer or a domain expert to label a relation as important or not to be consistent at all time. For example, in RUBiS benchmark, for relation items, we can label attributes “quantity” and “seller_id” to be important to be consistent, while others (such as number of bids and category) are not important, because any inconsistency in the former two attributes can potentially cause problems (such as over-sell). Based on the importance labeling of attributes (denoted as A^{I}), we can derive weights of joins in a transaction graph TG. In general, for database operations, we can consider reading less important than updates unless we are told certain attributes must be consistent (e.g., in A^{I}). So the first step is to identify all edges in the transaction graph that directly affects: 1) update, insert, and delete operations, and 2) output. In this set, if any edge's annotation contains an attribute labeled as important, we mark it as an important edge. In order for an important edge to be consistent, a necessary condition is there is at least one consistent path from the Input node, meaning that all the edges in the path are consistent. This gives us the following procedure for deriving join weights.

First, for each important edge e we identified, we give it a fixed amount of balance of value 1. All other edges have a balance of zero. In a bottom-up fashion (from the edges that are farthest from the Input node), for each e, identify if there is only one unique path from Input to its source node. If so, we increase the balance of each edge along the path by the amount of the current balance of e. If there are multiple paths, since we do not know in advance which path the query execution engine will take, we consider that all paths are possible. Therefore, we distribute the balance each path evenly and increase the balance of each edge along the paths accordingly. Finally, once all important edges are processed, we have the edge weight assignment for this transaction graph. This strategy can be easily tweaked to include variable weights on different attributes if the user prefers.

We built a prototype system capable of deriving entity-groups for relational workloads. This prototype contains the following modules.
Workload Visualization After the user chooses a workload to work with, we visualize the transactions and queries using graphs, as we introduced in Sec. 2.1. Each green box on the right panel depicts a transaction. This helps users understand the workload and make design choices such as deciding if an edge needs to be covered.
Design Engine The system initially does a best-effort design and produces a set of entity-groups, using the multiplicity edge weight scheme.
User Feedback The user can inspect the initial design, and provide feedback in the form of if an edge or transaction should be covered or she is neutral. The system takes this input into account and refines the design. In case of conflicting user requirements, the system informs the user to take further actions to resolve them.
Output Visualization After the user produces the final design output, we produce a graphical representation of the entity-group designs. The lower-left corner visualizes the entity-group “by_author”, which involves table author, item, and shopping cart line. This helps the user grasp the designs results and make adjustments if necessary.

As discussed above, our system automatically derives entity-group designs for an OLTP workload given its schema and transactions. Entity-group based systems limit the scope of ACID to be inside a collection of entities residing in a single machine, and they have been proven to be highly scalable. To manually design entity-groups, which is what developers have been doing, is a daunting task because of both the complexity of the workload and difficulty of trading consistency for performance. We automate this process by providing an end-to-end solution, from schema and workload to entity-group designs; we also provide users tools to tune the design towards their application needs of consistency or performance. We use TPC-W and RUBiS benchmarks for case study and show how our automated tool can relieve application developers from the pain of manually designing entity-groups while achieving the balance between consistency and performance.

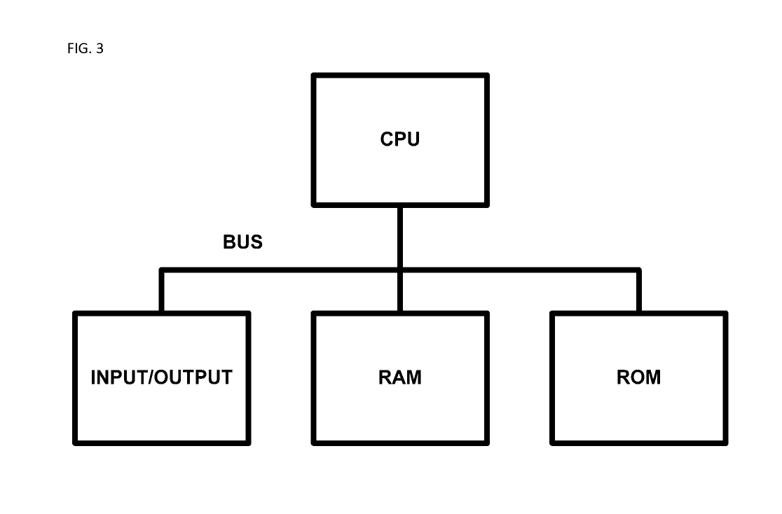

The invention may be implemented in hardware, firmware or software, or a combination of the three. FIG. 3 shows an exemplary computer to execute FIGS. 1-2. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself

What is claimed is:

1. A method for automatic database design for scalability, comprising:
receiving a database schema and database workload;
applying transaction chopping to split a large transaction into smaller transactions;
select one or more transactions using dynamic programming based on transaction weights;
deriving a database design that covers the selected transactions; and
generating a transaction class design that is scalable.

2. The method of claim 1, comprising applying transaction chopping for online transaction processing workloads.

3. The method of claim 1, comprising supporting full transaction coverage in design

4. The method of claim 3, comprising applying dynamic programming to select a subset of transactions that maximizes total benefit.

5. The method of claim 1, comprising supporting partial transaction coverage.

6. The method of claim 5, comprising using the frequency that a join appears in a workload to assign a weight to a join and applying the weight in a greedy selection method to select joins in case of conflict.

7. The method of claim 5, comprising receiving input from a user on a join's attribute importance and automatically adjusting a weight of the join.

8. The method of claim 7, comprising applying the weight in a greedy selection method to select joins.

9. The method of claim 5, comprising selecting a set of trees from a schema graph to represent a transaction class design and applying a greedy selection method to select joins.

10. The method of claim 5, comprising profiling the database's performance and applying the profiling to detect bottlenecks in the design.

11. The method of claim 10, comprising splitting the design that causes one object to receive excessive traffic.

12. The method of claim 1, comprising supporting consistency constraints in the design.

13. The method of claim 13, comprising representing consistency constraints as SQL queries and adding the SQL queries in a workload mix when designs are derived.

14. A method for automatic database design for scalability, comprising:
receiving a database schema and database workload;
applying transaction chopping to split a large transaction into smaller transactions;
analyzing a frequency of appearance in the database workload of each join in the schema;
weighing each join by either frequency of appearance or automatic weight derivation based on labeling of attributes;
applying a greedy design method to pick a predetermined join when a conflict exists; and
generating a transaction class design that is scalable.

15. The method of claim 14, comprising applying transaction chopping for online transaction processing workloads.

16. The method of claim 14, comprising supporting full transaction coverage in design

17. The method of claim 14, comprising supporting partial transaction coverage.

18. The method of claim 14, comprising supporting consistency constraints in the design.

19. The method of claim 14, comprising supporting consistency constraints in the design.

20. The method of claim 19, comprising representing consistency contraints as SQL queries and adding the SQL queries in a workload mix when designs are derived.
